(19) United States
(12) Patent Application Publication
(10) Pub. No.: US 2024/0246125 A1
(43) Pub. Date: Jul. 25, 2024

(54) APPARATUS AND METHOD FOR RINSING THE INTERIOR OF A CONTAINER

(71) Applicant: KRONES AG, Neutraubling (DE)

(72) Inventor: Rupert Meinzinger, Neutraubling (DE)

(21) Appl. No.: 18/416,051

(22) Filed: Jan. 18, 2024

(30) Foreign Application Priority Data
Jan. 19, 2023 (DE) 10 2023 101 236.3

(51) Int. Cl. B08B 9/34; B08B 9/08

(52) U.S. Cl. CPC B08B 9/34; B08B 9/0813; B08B 2209/08

(57) ABSTRACT

An apparatus for rinsing the interior of a container, for example a drinks bottle in a drink filling installation, includes a container receiving member for receiving a container that is configured to hold the container at least for a rinsing operation in a predetermined position in which the container is orientated with respect to a longitudinal axis of the container and/or a centre axis of the container opening with respect to gravitational acceleration at an inclination angle with a downwardly directed container opening and a rinsing nozzle for introducing a jet of rinsing fluid through the container opening into the container. The rinsing nozzle is arranged and configured to introduce the jet of rinsing fluid into the container opening in a state orientated at an introduction angle with respect to the longitudinal axis of the container and/or the centre axis of the container opening. A corresponding method is described.

### CROSS-REFERENCE TO RELATED APPLICATIONS

This application claims priority from German Patent Application No. DE 10 2023 101 236.3, filed on Jan. 19, 2023 in the German Patent and Trademark Office, the disclosure of which is incorporated herein by reference in its entirety.

### BACKGROUND

### Technical Field

The present invention relates to an apparatus and a method for rinsing the interior of a container, for example, a drinks bottle in a drink filling installation.

### Related Art

It is known to rinse containers which are provided for filling with a filling material, for example, with a drink, prior to the filling. For example, the containers may be provided in the form of bottles which are rinsed out prior to the actual filling with the desired filling material. In this instance, the containers are held with their container opening downwards, that is to say, in the direction of gravitational acceleration or the vector thereof, by means of a conveyor device and transported. From below, a rinsing fluid is injected through the container opening into the interior of the containers, for example, water or water which is provided with surfactants.

For the most uniform possible rinsing of the interior of the container which is subsequently intended to be filled, the jet of rinsing fluid is introduced in such a manner that it strikes the container base centrally in order to rinse the interior of the container in the most uniform manner possible from the base to the container opening.

In order to further increase the cleaning action, the jet of rinsing fluid can be reinforced with compressed air.

In order to extend the time for rinsing, it is known to activate the rinsing jet already when the containers are pivoted upwards and downwards into or out of the rinsing position, wherein the rinsing jet is guided in a pendulum movement through the container opening in the direction of the container base. A movable nozzle may also be provided, by means of which the rinsing jet can already be introduced into the interior of the container before it is located above the nozzle which discharges the rinsing fluid. Such an apparatus which provides a rinsing of the interior of a container may, for example, be derived from EP 2 289 640 A1.

Furthermore, it is known to hold the containers whilst the rinsing fluid is introduced into the interior of the container with respect to the longitudinal axis of the container at an angle with respect to gravitational acceleration, as can be derived, for instance, from JP 2001 000 940 A or U.S. Pat. No. 1,904,685 A.

### SUMMARY

An improved apparatus for rinsing the interior of a container, for example a drinks bottle in a drink filling installation, and a corresponding method are described herein according to various embodiments.

Accordingly, an apparatus for rinsing the interior of a container, for example a drinks bottle in a drink filling installation, is proposed, comprising a container receiving member for receiving a container intended to be rinsed which is configured to hold the container to be cleaned at least for a rinsing operation in a predetermined position in which the container is orientated with respect to the longitudinal axis of the container and/or a centre axis of the container opening with respect to gravitational acceleration at an inclination angle with a downwardly directed container opening and a rinsing nozzle for introducing a jet of rinsing fluid through the container opening into the container.

The rinsing nozzle is arranged and configured to introduce the jet of rinsing fluid into the container opening in a state orientated at an introduction angle with respect to the longitudinal axis of the container and/or the centre axis of the container opening. In other words, the rinsing nozzle is arranged with the geometric nozzle axis thereof at the introduction angle relative to the longitudinal axis and/or the centre axis when the container is located in the predetermined position in which the container receiving member predetermines or defines the longitudinal axis of the container and the centre axis of the container opening.

In other words, the container receiving member comprises a receiving axis which corresponds to the longitudinal axis of the container which is received therein, wherein the container receiving member in the predetermined position is inclined with the receiving axis thereof through an inclination angle φ with a downwardly facing receiving opening counter to gravitational acceleration.

As a result of the fact that the rinsing nozzle is arranged and configured to introduce the jet of rinsing fluid into the container opening in a state orientated at an introduction angle with respect to the longitudinal axis of the container and/or the centre axis of the container opening, a wetting and a resultant contamination of the rinsing nozzle with the rinsing fluid which is discharged again from the container interior and the discharged dirt particles can be reduced or even completely prevented. Accordingly, any contamination of the rinsing nozzle which may occur with conventional apparatuses and a resultant contamination of a subsequent container with a previously rinsed container, that is to say, a displacement of particles such as germs or droplets, or a contamination from container to container, can be reduced or even completely prevented.

Since the container is positioned at the inclination angle relative to gravitational acceleration, the rinsing fluid can run out of the container interior under the action of gravitational force, without dropping on the rinsing nozzle or only to a small extent. The oblique position of the orientation of the rinsing nozzle relative to the longitudinal axis of the container and/or the centre axis of the container opening with the introduction angle enables the rinsing nozzle, in comparison with arrangements in which the rinsing nozzle is positioned in the direction of the longitudinal axis of the container and/or with respect to the centre axis of the container opening, to be able to be positioned closer to the container opening, in particular since the discharge behaviour of the rinsing fluid from the container interior is advantageous with respect to an orientation which is orientated in the direction of the longitudinal axis and/or centre axis. As a result of the comparatively small spacing, the rinsing of the inner wall in particular in an upper region of the container interior can be carried out in a comparatively effective and uniform manner. This is because, with a comparatively large spacing, the quality, in particular the effectiveness and the uniformity, of the rinsing result in the upper region of the container wall may be reduced.

The container receiving member is in several embodiments constructed and configured to receive containers with predetermined dimensions.

The containers to be rinsed are in many embodiments constructed in such a manner that the longitudinal axis thereof and the centre axis of the container opening coincide. In other words, the longitudinal axis of the container then corresponds to the centre axis of the container opening and vice versa. Accordingly, the container is then orientated with respect to the longitudinal axis and the centre axis of the container opening with respect to gravitational acceleration at the inclination angle with a downwardly facing container opening.

A particularly effective rinsing can be achieved when the container is constructed in a rotationally symmetrical manner, such as, for example, with bottles according to DIN 6075, or axially symmetrical with respect to the longitudinal axis thereof. The longitudinal axis and the centre axis of the container opening then also coincide.

According to one embodiment, a centre axis of the jet of rinsing fluid may have an offset with respect to the longitudinal axis of the container and/or the centre axis of the container opening, wherein the offset is in some embodiments in a range greater than zero and less than the inner radius of the container opening. In other words, the nozzle axis of the rinsing nozzle may be arranged with an offset with respect to the longitudinal axis of the container and/or the centre axis of the container opening. The centre axis of the jet of rinsing fluid and the longitudinal axis of the container are consequently skewed with respect to each other, they do not intersect. In other words, the nozzle axis of the rinsing nozzle and the longitudinal axis of the container are skewed with respect to each other, they do not intersect.

The rinsing nozzle can consequently be arranged in a state orientated in such a manner that the rinsing fluid in the container interior after initially striking the jet of rinsing fluid discharged from the rinsing nozzle at an impact location on the inner surface of the container interior is subjected to swirling with respect to the inner surface, that is to say, flows through the container interior with swirling. It is thereby possible for the inner surface as a result of the resultant propagation of the rinsing fluid to be wetted substantially completely with rinsing fluid.

In addition, it is possible to prevent the jet of rinsing fluid which is discharged from the rinsing nozzle and the discharged rinsing fluid from crossing, which could otherwise lead to a redirection and/or weakening of the rinsing jet. Flow over the inner surface by means of a rotating rinsing fluid has surprisingly been found in tests to be additionally advantageous since the rinsing fluid is capable of touching substantially the complete inner surface for a longer period of time with higher force than is possible with conventional apparatuses from the prior art. The higher cleaning force is introduced by the rotational pulse or swirl by the centrifugal force. As a result of the rotation of the rinsing fluid, the rinsing fluid also travels a longer path than when the rinsing fluid is introduced in a linear manner. This results in a longer contact time or active time of the rinsing fluid on the inner surface. In comparison with conventional apparatuses with linear introduction, this means that, for the same predetermined active time, less rinsing fluid is required by the apparatus according to the invention.

In one or more embodiments, the rinsing nozzle is arranged in such a manner that the jet of rinsing fluid strikes the inner surface of the container in a neck region and/or in a shoulder region of the container. An in particular comprehensive and uniform wetting of the inner surface of the container interior can thus be achieved.

In order to achieve a planar propagation of the rinsing fluid along the inner surface in the direction of the container base with the least possible tendency to spray upon impact, the rinsing nozzle can be arranged in such a manner that the jet of rinsing fluid, more specifically the centre axis thereof or the rotation axis of the rinsing nozzle, at the impact location thereof on the inner surface of the container, encloses an angle of from 85° to 90° with the surface normal of the inner surface at the impact location, wherein the jet of rinsing fluid, more specifically the centre axis thereof or the nozzle axis of the rinsing nozzle, is in certain embodiments orientated at the impact location in some embodiments substantially tangentially with respect to the inner surface.

The introduction angle is in several embodiments in a range from 5° to 45°, for example from 10° to 30°, in one embodiment from 15° to 25°. In many embodiments, it is 18°, 19°, 20° or 21°.

Alternatively or additionally, the inclination angle may be in a range from 10° to 80°, for example from 15° to 75°, in one embodiment from 20° to 60° and in some embodiments may be 25°, 30°, 35°, 40°, 45°, 50° or 55° or be in a range between two of the above-mentioned individual values.

According to another embodiment, the rinsing nozzle can be arranged in the direction of the longitudinal axis of the container and/or the centre axis of the container opening with a predetermined spacing with respect to the container opening. The spacing is in this instance intended to be understood to be the extent in the direction of the longitudinal axis of the container or the centre axis of the container opening which is present between an intersection of a plane defined by the container opening transversely relative to the longitudinal axis or centre axis and the longitudinal axis or centre axis, on the one hand, and a projection perpendicularly to the longitudinal axis or centre axis of the tip, that is to say, the discharge location of the jet of rinsing fluid of the rinsing nozzle onto the longitudinal axis or centre axis, on the other hand.

In one or more embodiments, the spacing in the direction of the longitudinal axis is greater than the quotient of an inner radius of the container opening and the tangent of the inclination angle. The tip of the rinsing nozzle is then located in a horizontal direction, that is to say, when viewed perpendicularly to gravitational acceleration, not below the container opening but instead with a horizontal spacing with respect to the container opening.

The spacing is in many embodiments greater than or equal to the product of a predetermined factor k and the quotient of an inner radius of the container opening and the tangent of the inclination angle, wherein the factor k is in various embodiments between 1.1 and 8. Alternatively or additionally, the spacing may be at least 10 mm, for example at least 20 mm, in one embodiment 30 mm, and/or a maximum of 150 mm, in some embodiments a maximum of 100 mm, in certain embodiments a maximum of 80 mm and in several embodiments a maximum of 50 mm. In the above-mentioned range of the spacing, on the one hand, it is possible for the rinsing nozzle not to be hit by rinsing fluid which is being discharged from the container again and/or particles. In addition, an effective and uniform rinsing of the entire inner surface of the container interior can be enabled.

According to another embodiment, the rinsing nozzle may be arranged with respect to gravitational acceleration laterally offset with respect to the container opening, wherein a horizontal spacing perpendicular to gravitational acceleration between the container opening and rinsing nozzle is in various embodiments at least 5 mm, for example at least 7.5 mm, in one embodiment at least 10 mm, and in certain embodiments is 15 mm, 20 mm, 25 mm or 30 mm.

According to another embodiment, the rinsing nozzle may have a nozzle diameter of from 1 mm to 4 mm, for example from 1.5 mm to 2.5 mm.

A rinsing pressure of the rinsing fluid in the rinsing nozzle may in one or more embodiments be from 2 bar to 10 bar, for example from 3 bar to 8 bar, in an exemplary embodiment from 5 bar to 7 bar.

According to another embodiment, the apparatus or the rinsing nozzle may be configured to intermittently rinse the container, wherein there are in certain embodiments provided at least two rinsing periods, in which the container is acted on with the rinsing fluid, and there is provided between two successive rinsing periods and in some embodiments after the last rinsing period a discharge period in which rinsing fluid which has been introduced into the container can run out of the container as a result of gravitational force. At least one rinsing period, in several embodiments a plurality of rinsing periods, in an exemplary embodiment all the rinsing periods, are for example between 0.2 and 1.5 seconds, in one embodiment from 0.4 to 0.8 seconds and in various embodiments 0.5 seconds. The rinsing periods may be of the same length or alternatively of different lengths.

In one or more embodiments, the apparatus comprises a control apparatus which is not shown here for controlling the jet of rinsing fluid during the intermittent introduction of the jet of rinsing fluid into the container interior.

The discharge periods may for example be between 0.5 and 5 seconds, such as from 0.75 to 3 seconds and in one embodiment from 1 to 2 seconds. The discharge periods may be of the same length or different lengths.

In various embodiments, precisely three, four, five, six, seven, eight, nine or ten rinsing periods are provided.

A method for rinsing the interior of a container, for example a drinks bottle in a drink filling installation is also described here according to certain embodiments.

Accordingly, a method for rinsing the interior of a container, for example a drinks bottle in a drink filling installation, is proposed, involving holding a container to be cleaned in a predetermined position in which the container is held with respect to a longitudinal axis of the container and/or the centre axis of the container opening with respect to gravitational acceleration at a predetermined inclination angle with a downwardly directed container opening and introducing a jet of rinsing fluid through the container opening into the container.

The jet of rinsing fluid is introduced into the container opening in a state orientated at an introduction angle with respect to the longitudinal axis of the container and/or the centre axis of the container opening.

As a result of the method, the advantages and effects mentioned above with regard to the apparatus and mentioned below with regard to the Figures can be achieved in a similar manner. They are accordingly not repeated at this point in order to avoid redundancy.

In several embodiments, a centre axis of the jet of rinsing fluid when introduced into the container interior has an offset with respect to the longitudinal axis of the container and/or the centre axis of the container opening, wherein the offset is in certain embodiments in a range greater than zero and less than the inner radius of the container opening.

During the introduction, the jet of rinsing fluid in several embodiments strikes the inner surface of the container in a neck region and/or in a shoulder region of the container.

The jet of fluid is in some embodiments introduced into the container interior in such a manner that it encloses at the impact location on the inner surface of the container with the surface normal of the inner surface at the impact location an angle of from 85° to 90°, wherein the jet of rinsing fluid at the impact location is in one or more embodiments orientated substantially tangentially with respect to the inner surface.

According to one embodiment, the introduction angle during the introduction is in a range from 5° to 45°, for example from 10° to 30°, in an exemplary embodiment from 15° to 25°. It may in many embodiments be 18°, 19°, 20° or 21°.

The inclination angle may according to one embodiment be in a range from 10° to 80°, for example from 15° to 75°, in some embodiments from 20° to 60° and in one embodiment from 25°, 30°, 35°, 40°, 45°, 50° or 55° and/or may be in a range between two of the above-mentioned individual values.

At least during the introduction, the rinsing nozzle for introducing the jet of rinsing fluid in the direction of the longitudinal axis of the container and/or the centre axis of the container opening can be held with a predetermined spacing with respect to the container opening, wherein the spacing is in several embodiment greater than the quotient of an inner radius of the container opening and the tangent of the inclination angle, wherein the spacing is in certain embodiments greater than or equal to the product of a predetermined factor k and the quotient of an inner radius of the container opening and the tangent of the inclination angle, wherein the factor k is in various embodiments between 1.1 and 8, and/or the spacing is at least 10 mm, for example at least 20 mm, in certain embodiments 30 mm and/or the spacing is a maximum of 150 mm, for example a maximum of 100 mm, in one embodiment a maximum of 80 mm and in an exemplary embodiment a maximum of 50 mm.

According to one embodiment, the rinsing nozzle for introducing the jet of rinsing fluid can be held with respect to gravitational acceleration laterally offset with respect to the container opening, wherein a horizontal spacing perpendicular to gravitational acceleration between the container opening and rinsing nozzle is for example at least 5 mm, for example at least 7.5 mm, in one embodiment at least 10 mm, and in various embodiments is at least 15 mm, 20 mm, 25 mm or 30 mm.

According to one embodiment, the jet of rinsing fluid during discharge from a rinsing nozzle may have a diameter of from 1 mm to 4 mm, for example from 1.5 mm to 2.5 mm and/or a rinsing pressure of the rinsing fluid may be from 2 bar to 10 bar, for example from 3 bar to 8 bar, in one embodiment from 5 bar to 7 bar.

According to one embodiment, the container may be intermittently rinsed, wherein there are in one or more embodiments provided at least two rinsing periods in which the container is acted on with the rinsing fluid, and there is provided in each case between two successive rinsing periods and in some embodiments after the last rinsing period a discharge period, in which rinsing fluid which has been introduced into the container can run out of the container as a result of gravitational force, wherein the rinsing periods are between 0.2 and 1.5 seconds, for example from 0.4 to 0.8 seconds and in one embodiment 0.5 seconds, wherein all the rinsing periods are in several embodiments of the same length or the rinsing periods are of different lengths, and/or wherein the discharge periods are in certain embodiments between 0.5 and 5 seconds, for example from 0.75 to 3 seconds and in an exemplary embodiment from 1 to 2 seconds, wherein all the discharge periods are in various embodiments of the same length or the discharge periods are of different lengths, and/or wherein precisely three, four, five, six, seven, eight, nine or ten rinsing periods are in several embodiments provided.

The step of introduction can consequently be subdivided into a plurality of alternately successive rinsing periods and discharge periods.

### BRIEF DESCRIPTION OF THE FIGURES

Exemplary additional embodiments of the invention will be explained in greater detail below by the following description of the Figures, in which:

FIG. 1 shows a schematic side view of an apparatus for rinsing the interior of a container;

FIG. 2 shows a schematic detailed view of the apparatus from FIG. 1;

FIG. 3 shows a schematic perspective side view of a detail of the apparatus from FIG. 1;

FIG. 4 shows a schematic sectioned view through a container which is held in the container holder of the apparatus from FIG. 1 perpendicularly to the longitudinal axis thereof;

FIG. 5 shows schematically in detail a geometric relationship between the longitudinal axis and a jet of rinsing fluid;

FIG. 6 shows a schematic side view of the container of the apparatus from FIG. 1 in a state held in the container receiving member;

FIG. 7 shows a schematic perspective side view of the container from FIG. 6 in a state held in the container holder during discharge of rinsing fluid; and

FIG. 8 shows a schematic flow chart of a method for rinsing the interior of a container.

### DETAILED DESCRIPTION

Exemplary embodiments are described below with reference to the Figures. In this instance, elements which are identical, similar or have the same effect are given identical reference numerals in the different Figures and a repeated description of these elements is partially omitted in order to avoid redundancies.

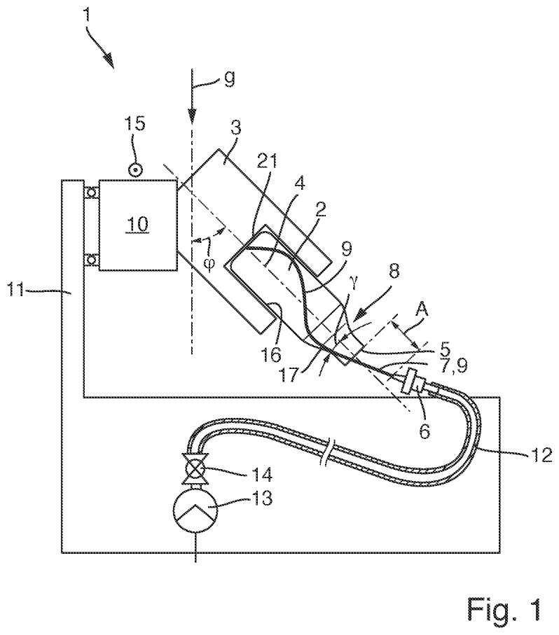

FIG. 1 shows a schematic side view of an apparatus 1 for rinsing the interior of a container 2, in this instance a drinks bottle in a drink filling installation.

The apparatus 1 comprises a container receiving member 3 for receiving a container 2 which is intended to be rinsed and which has predetermined dimensions. It is constructed and configured to hold the container 2 which is intended to be cleaned at least for a rinsing operation, as described in greater detail with reference to the following Figures, in a predetermined position in which the container 2 with respect to the longitudinal axis 4 of the container 2 which, as a result of the rotationally symmetrical construction of the container 2 with respect to the longitudinal axis 4, also corresponds to a centre axis of the container opening 5 of the container 2, is orientated with respect to gravitational acceleration g, more specifically with respect to the directional vector of gravitational acceleration g in the direction towards the centre of the Earth, at an inclination angle φ with a downwardly directed container opening 5. In other words, the container receiving member 3 comprises a receiving axis which corresponds to the longitudinal axis 4 of the container 2 which is received therein, wherein the container receiving member 3 is inclined with the receiving axis thereof through the inclination angle φ with a downward facing receiving opening counter to gravitational acceleration g.

The apparatus 1 further comprises a rinsing nozzle 6 for introducing a jet 7 of rinsing fluid 9 through the container opening 5 into the container interior.

The rinsing nozzle 6 is arranged in such a manner that the jet 7 of rinsing fluid which is discharged from the rinsing nozzle 6 enters the container opening 6 in a state orientated at an introduction angle γ with respect to the longitudinal axis 4 of the container 2, that is to say, also with respect to the centre axis of the container opening 5.

According to this optional embodiment, the container holder 3 is arranged on a transport unit 10 which can be moved relative to the frame 11 with respect to a fixed frame 11 of the apparatus 1 in a transport direction 15 which protrudes perpendicularly to the drawing plane in FIG. 1. In a similar manner, the transport apparatus 10 comprises a plurality of container receiving members 3.

In order to provide and switch off the jet 7 of rinsing fluid 9, the apparatus 1 optionally comprises a pump 13 which is in this instance in a non-limiting manner in the form of a high-pressure water pump, which provides a pressure of 7 bar, and further a valve 14 which in this instance is in a non-limiting manner in the form of an electromagnetically controlled shut-off valve in order to supply rinsing fluid 9 to the rinsing nozzle which in this instance and in a non-limiting manner is in the form of a full jet nozzle having a nozzle diameter of 2 mm in the open switching state via a line 12.

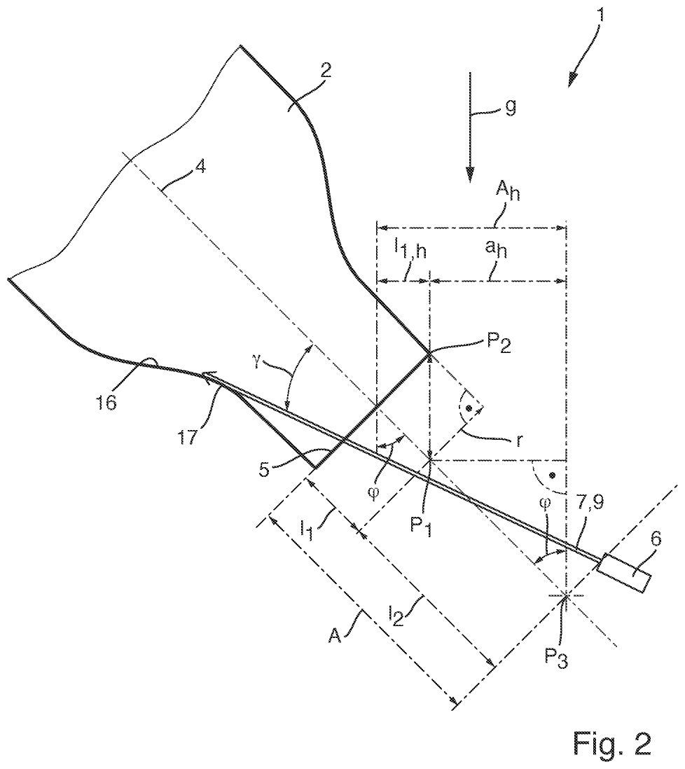

As can be derived more specifically from FIG. 2 below, the rinsing nozzle 6 is arranged in such a manner that the jet 7 of rinsing fluid 9 in a shoulder region 8 of the container 2, that is to say, a region in which the transition from the bottle neck to the bottle body is located, strikes the inner surface 16 of the container 2 for the first time at an impact location 17.

From the impact location 17, the rinsing fluid 9 moves on the inner surface 16 of the container 2 up to the container base 21 which is arranged opposite the container opening 5.

The rinsing nozzle 6 is arranged in the direction of the longitudinal axis 4 of the container 2 with a spacing A with respect to the container opening 5, as explained in greater detail with respect to FIG. 2. As a result of the arrangement of the rinsing nozzle 6 with spacing with respect to the container opening 5 in combination with the container receiving member 3 which is positioned at the inclination angle φ, it is possible for rinsing fluid 9 which is being discharged from the container 2 again not to reach the rinsing nozzle 6.

In this instance and in a non-limiting manner, the inclination angle φ is 45°, the introduction angle γ is 19°, the pressure 7 provided by the pump 13 is 7 bar and the spacing A is 40 mm.

The rinsing nozzle 6 is in this instance arranged in such a manner that the jet 7 of rinsing fluid 9 is orientated at the impact location 17 thereof on the inner surface 16 of the container 2 substantially tangentially with respect to the inner surface 16.

FIG. 2 shows schematically a detailed view of the apparatus 1 from FIG. 1. It represents a sectioned view along the longitudinal axis 4 and through the impact location 17. There are indicated therein with the reference numeral r the radius of the container opening 5, with the reference numeral P1 the projection location of the rinsing nozzle 6 in a horizontal direction, that is to say, perpendicularly to gravitational acceleration g, at the closest location P2 of the container opening 5 in the direction of gravitational acceleration g onto the longitudinal axis 4, with the reference numeral P3 a projection of the nozzle tip 18 of the spray nozzle 6 in the direction of gravitational acceleration g onto the longitudinal axis 4, with the reference numeral Ah the projection of the spacing A in a plane perpendicular to gravitational acceleration g, and with the reference numeral ah a horizontal spacing perpendicular to gravitational acceleration g between the container opening 5 and rinsing nozzle 6.

The spacing A is subdivided in the longitudinal direction 4 by the projection location P1 into a first length 11 and a second length 12. Accordingly, the horizontal projection of the spacing Ah is subdivided into a first horizontal length lh,1 and the horizontal spacing ah.

From the above indications, the following relationships can be derived:

$$tan φ = \frac{r}{{l}_{1}} \qquad ( 1 )$$

$${l}_{1} = \frac{r}{tan φ} \qquad ( 2 a )$$

$${l}_{2} = \frac{{a}_{h}}{tan φ} \qquad ( 2 b )$$

$$A = {l}_{1} + {l}_{2} \qquad ( 3 )$$

$$A = \frac{r}{tan φ} + \frac{{a}_{h}}{tan φ} \qquad ( 4 )$$

Accordingly, the rinsing nozzle 6 when viewed in the direction of gravitational acceleration g is not located below the container opening 5, but instead in a horizontal direction beside or with spacing from the container opening 5, when

$$A > \frac{r}{tan φ} \qquad ( 5 )$$

Accordingly, the spacing A is in several embodiments greater than the quotient of an inner radius of the container opening and the tangent of the inclination angle φ, as expressed in the equation (5). The spacing A is in some embodiments greater than or equal to the product of a predetermined factor k and the quotient of the inner radius r of the container opening 5 and the tangent of the inclination angle q, thus

$$A = k * \frac{r}{tan φ} \qquad ( 6 )$$

The rinsing nozzle is then arranged with respect to gravitational acceleration laterally offset with respect to the container opening, wherein the horizontal spacing ah perpendicular to gravitational acceleration g between the container opening 5 and rinsing nozzle 6 is in various embodiments at least 5 mm, in one or more embodiments at least 7.5 mm, for example at least 10 mm, and in an exemplary embodiment at least 15 mm, 20 mm, 25 mm or 30 mm.

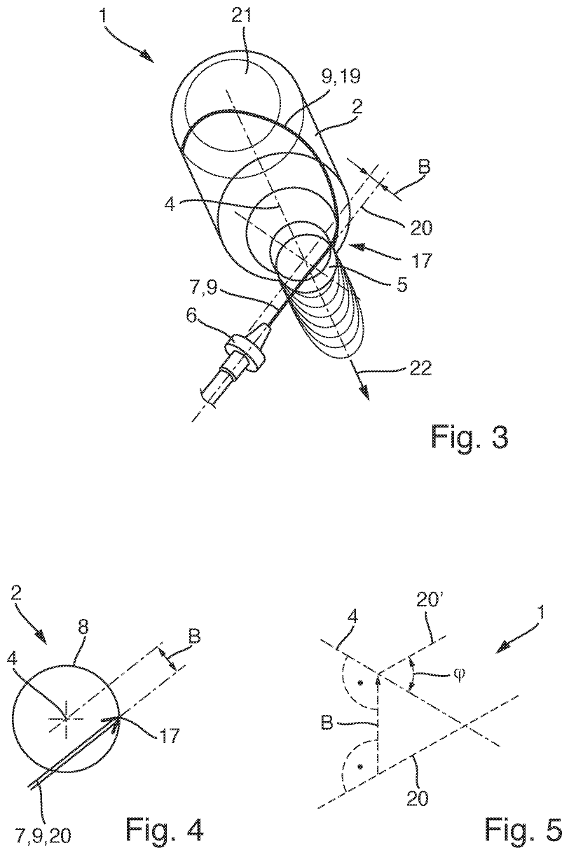

FIG. 3 shows a schematic, perspective side view of a detail of the apparatus 1 from FIG. 1. For reasons of clarity, the container holder 3 is not also illustrated, but instead only the container 2 which is held therein.

A nozzle axis of the rinsing nozzle 6 and consequently also the centre axis 20, which corresponds to the nozzle axis, of the jet 7 of rinsing fluid 9 discharged from the rinsing nozzle 6 is arranged with an offset B with respect to the longitudinal axis 4 of the container 2 and the centre axis of the container opening 5. In this instance, the offset B is located in a range greater than zero and less than the inner radius r of the container opening 5. The centre axis 20 of the jet 7 of rinsing fluid 9 and the longitudinal axis 4 of the container 2 are consequently skewed with respect to each other, they do not intersect. The rinsing nozzle 6 is consequently arranged in a state orientated in such a manner that the rinsing fluid 9 in the container interior after the jet 7 of rinsing fluid 9 discharged from the rinsing nozzle 6 at the impact location 17 initially strikes the inner surface 16 of the container interior is subjected to swirling, that is to say, flows through the container interior in a state subjected to swirling. This results in a helical path, as indicated by the reference numeral 19 for the flow of rinsing fluid on the inner surface 16 in the direction of the container base 21. It is thereby possible for the inner surface 16 as a result of the resultant propagation of the rinsing fluid 9 in the container interior to be wetted with rinsing fluid 9 substantially completely and in a particularly uniform manner. In addition, there is an advantageous outwardly surging flow from the container interior, as indicated with the reference numeral 22.

FIG. 4 schematically shows a sectioned view through the container 2 which is retained in the container holder (not shown) perpendicularly to the longitudinal axis 4 at the height of the impact location 17, from which the offset B between the longitudinal axis 4 and centre axis 20 can be seen clearly again.

FIG. 5 shows schematically in detail the geometric relationship between the longitudinal axis 4 and centre axis 20. When the longitudinal axis 4 and centre axis 20 are skewed with respect to each other, the inclination angle φ is produced as the (smaller) intersection angle which is enclosed between the longitudinal axis 4 and a parallel line 20′ of the centre axis 20 which is displaced via parallel displacement of the centre axis 20 by the offset B onto the longitudinal axis 4.

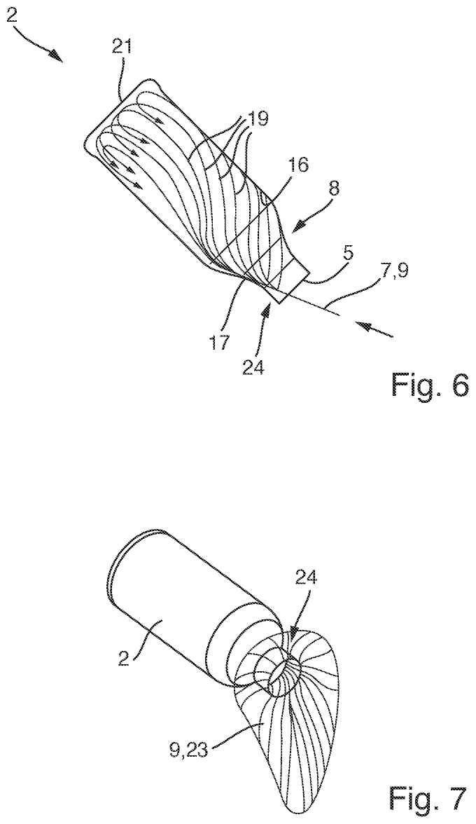

FIG. 6 shows a schematic side view of the container 2 which is held in the container receiving member 3, from which a graphic illustration of the outwardly fanning flow 19 of rinsing fluid 9 after striking the inner surface 16 of the container 2 at the impact location 17 can be derived.

From the impact location 17, the flow 19 of rinsing fluid 9 propagates as a result of the tangential flow direction which is introduced obliquely, that is to say, in a state skewed with respect to the longitudinal axis 4, in a helical manner with outward fanning with respect to the container base 21. In this instance, substantially the complete inner surface 16 is flowed over. When the inner surface 16 is flowed over by means of the rotating rinsing fluid 9, there is in comparison with embodiments with a linear inflow, in which the centre axis of the jet 7 intersects the longitudinal axis 4, an increased active time period of the rinsing fluid 9 on the inner surface 16. In addition, as a result of the rotary pulse (swirl), a higher cleaning force is achieved. It is also advantageous that, as a result of the helical or helix-like and outwardly fanning flow, the rinsing fluid 9 travels a longer path, from which a longer contact time is produced. Accordingly, for a predetermined active time with a swirling inflow, less water is required than with an inflow of rinsing fluid without swirling being generated.

As soon as the rinsing fluid 9 has flowed over the inner surface 16 on the container base 21, the rotating rinsing fluid 9 accumulates on the container base 21 and cleans the container base 21 by means of the rotation thereof.

The rinsing period, that is to say, the time period in which the jet 7 of rinsing fluid 9 is introduced into the container 2, is predetermined in such a manner that the supply of the rinsing fluid 9 is interrupted before so much rinsing fluid 9 has accumulated on the container base 21 that, as a result of gravitational force, the rinsing fluid 9 which has accumulated runs out in a downward direction again in the direction of the container opening 5. Consequently, the quantity of rinsing fluid 9 which has been introduced on the container base 21 can reverse with rotation as a result of gravitational force without being significantly impeded or braked in the present movement direction thereof downwards in the direction of the container opening. After the reversal of the flow 20 of rinsing fluid 9 in the direction of the container opening 5, the rinsing fluid 9 is still subjected to rotation and flows over the inner surface 16, in particular also the neck region 24 of the container 2 again. This extends the active time without additional consumption of rinsing fluid 9. As a result of the rotation in the direction of the container opening 5, again substantially the complete inner surface 16 is flowed over, including the shoulder region 8 and the neck region 24.

The complete flowing over of the neck region 24 can be clearly seen with the so-called fluid screen 23 of rinsing fluid 9 which is formed on the container opening 5 when discharged from the container 2 and which can be derived from FIG. 7 which schematically shows a perspective side view of the container 2 which is held in the container holder 3 (not shown) with the above-described discharge of the rinsing fluid 9.

In order to further increase the rinsing action, the apparatus 1 or the rinsing nozzle 6 is configured and constructed to intermittently rinse the container 2. In one or more embodiments, the apparatus 1 comprises a control apparatus which is not shown in this instance for controlling the flow 7 of rinsing fluid 9. The control apparatus can be configured to control the pump 13 and/or the valve 14.

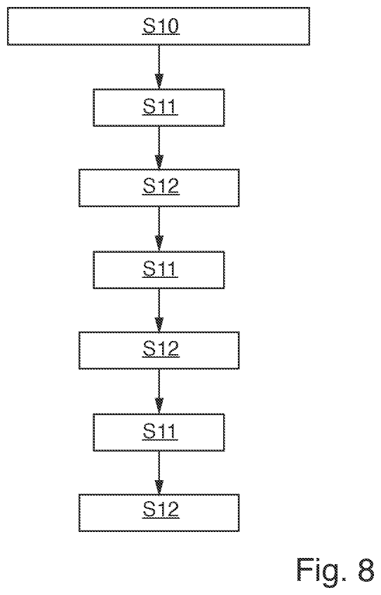

A corresponding method for rinsing the interior of a container 2, in this instance a drinks bottle in a drink filling installation, for the apparatus 1 from FIGS. 1 to 7 is explained below with regard to the schematic flow chart according to FIG. 8.

The method involves a step S10 of holding a container 2 which is intended to be cleaned in a predetermined position in which the container 2 is held with respect to the longitudinal axis 4 of the container 2 and in this instance in accordance with the centre axis of the container opening 5 with respect to gravitational acceleration g at the inclination angle φ with a downwardly directed container opening 5 and a step of introducing a jet 7 of rinsing fluid 9 through the container opening 5 into the container 2, wherein the jet 7 of rinsing fluid 9 is orientated into the container opening 5 with the introduction angle γ with respect to the longitudinal axis 4 of the container 2 and in accordance with the centre axis of the container opening 5.

The step of introducing the jet 7 of rinsing fluid 9, consequently the actual rinsing of the container interior, is carried out intermittently, as already explained above. The step of introduction is consequently subdivided into a plurality of rinsing periods S11 and discharge periods S12.

According to the optional embodiment according to FIG. 8, three rinsing periods S11 are provided, in which the interior of the container 2 is acted on with the rinsing fluid 9. Between two successive rinsing periods S11 and after the last rinsing period S11, there is provided in each case a discharge period S12 in which rinsing fluid 9 which has been introduced into the container 2, as has already been described in greater detail with respect to FIGS. 5 to 7, can flow out of the container 2 as a result of gravitational force.

In this instance and in a non-limiting manner, the rinsing periods S11 are 0.5 seconds, wherein in this instance all the rinsing periods S11 are of the same length. In this instance and in a non-limiting manner, the discharge periods S12 are in each case two seconds.

Where applicable, all the individual features which are illustrated in the exemplary embodiments can be combined with each other and/or interchanged without departing from the scope of the invention.

What is claimed is:

1. An apparatus for rinsing an interior of a container, comprising:
a container receiving member configured to receive and hold the container in a predetermined position in which the container is positioned with a container opening that is downwardly directed and is oriented at an inclination angle with respect to (1) a longitudinal axis of the container and/or a center axis of the container opening and (2) gravitational acceleration; and
a rinsing nozzle configured to introduce a jet of rinsing fluid through the container opening into the container, wherein the rinsing nozzle is arranged and further configured to introduce the jet of rinsing fluid into the container opening at an introduction angle with respect to the longitudinal axis of the container and/or the center axis of the container opening.

2. The apparatus of claim 1, wherein the rinsing nozzle is further arranged such that a center axis of the jet of rinsing fluid has an offset with respect to the longitudinal axis of the container and/or the center axis of the container opening, and the offset is a range greater than zero and less than an inner radius of the container opening.

3. The apparatus of claim 1, wherein the rinsing nozzle is further arranged such that the jet of rinsing fluid strikes an inner surface of the container in a neck region and/or in a shoulder region of the container.

4. The apparatus of claim 1, wherein the rinsing nozzle is further arranged such that the jet of rinsing fluid, at an impact location on an inner surface of the container, encloses an angle of from 85° to 90° with a surface normal of the inner surface at the impact location, and the jet of rinsing fluid is oriented at the impact location substantially tangentially with respect to the inner surface.

5. The apparatus of claim 1, wherein the introduction angle is in a range from 5° to 45° and/or the inclination angle is in a range from 10° to 80°.

6. The apparatus of claim 1, wherein the rinsing nozzle is further arranged in a direction of the longitudinal axis of the container and/or the center axis of the container opening with a spacing with respect to the container opening, wherein the spacing is (1) greater than a quotient of an inner radius of the container opening and a tangent of the inclination angle, (2) greater than or equal to a product of a predetermined factor and the quotient of the inner radius of the container opening and the tangent of the inclination angle, or (3) at least 10 mm.

7. The apparatus of claim 6, wherein the spacing is greater than or equal to a product of a predetermined factor and the quotient of the inner radius of the container opening and the tangent of the inclination angle, and the predetermined factor is between 1.1 and 8.

8. The apparatus of claim 1, wherein the rinsing nozzle is further arranged with respect to the gravitational acceleration to be laterally offset with respect to the container opening, and a horizontal spacing perpendicular to the gravitational acceleration between the container opening and the rinsing nozzle is at least 5 mm.

9. The apparatus of claim 1, wherein the rinsing nozzle has a nozzle diameter of from 1 mm to 4 mm and/or a rinsing pressure of the jet of rinsing fluid is from 2 bar to 10 bar.

10. The apparatus of claim 1, wherein the rinsing nozzle is further configured to intermittently rinse the container.

11. A method for rinsing an interior of a container, comprising:
holding the container in a predetermined position in which the container is positioned with a container opening that is downwardly directed and is oriented at an inclination angle with respect to (1) a longitudinal axis of the container and/or a center axis of the container opening and (2) gravitational acceleration; and
introducing, by a rinsing nozzle, a jet of rinsing fluid through the container opening into the container, wherein the jet of rinsing fluid is introduced into the container opening at an introduction angle with respect to the longitudinal axis of the container and/or the center axis of the container opening.

12. The method of claim 11, wherein a center axis of the jet of rinsing fluid has an offset with respect to the longitudinal axis of the container and/or the center axis of the container opening, and the offset is in a range greater than zero and less than an inner radius of the container opening.

13. The method of claim 11, wherein the jet of rinsing fluid strikes an inner surface of the container in a neck region and/or in a shoulder region of the container.

14. The method of claim 11, wherein the jet of rinsing fluid at an impact location on an inner surface of the container encloses an angle of from 85° to 90° with a surface normal of the inner surface at the impact location, and the jet of rinsing fluid is oriented at the impact location substantially tangentially with respect to the inner surface.

15. The method of claim 11, wherein the introduction angle is in a range from 5° to 45° and/or the inclination angle is in a range from 10° to 80°.

16. The method of claim 11, wherein the rinsing nozzle is arranged in a direction of the longitudinal axis of the container and/or the center axis of the container opening with a spacing with respect to the container opening, wherein the spacing is (1) greater than a quotient of an inner radius of the container opening and a tangent of the inclination angle, (2) greater than or equal to a product of a predetermined factor and the quotient of the inner radius of the container opening and the tangent of the inclination angle, or (3) at least 10 mm.

17. The method of claim 11, wherein the rinsing nozzle is arranged with respect to the gravitational acceleration to be laterally offset with respect to the container opening, wherein a horizontal spacing perpendicular to the gravitational acceleration between the container opening and the rinsing nozzle is at least 5 mm.

18. The method of claim 11, wherein the jet of rinsing fluid during discharge from the rinsing nozzle has a diameter of from 1 mm to 4 mm and/or a rinsing pressure of the jet of rinsing fluid is from 2 bar to 10 bar.

19. The method of claim 11, wherein the container is intermittently rinsed and the method further comprises:
providing at least two rinsing periods in which the container is rinsed with the jet of rinsing fluid; and
providing a discharge period between two successive rinsing periods where the jet of rinsing fluid that has been introduced into the container runs out of the container as a result of gravitational force.

20. The method of claim 19, wherein the at least two rinsing periods are between 0.2 and 1.5 seconds, and/or the discharge period is between 0.5 and 5 seconds.
